(19) United States
(12) Patent Application Publication
(10) Pub. No.: US 2009/0065478 A1
(43) Pub. Date: Mar. 12, 2009

(54) MEASURING ETCHING RATES USING LOW COHERENCE INTERFEROMETRY

(76) Inventors: Kevin P. Dockery, Rochester, NY (US); Michael A. Marcus, Honeoye Falls, NY (US); Kurt D. Sieber, Rochester, NY (US)

Correspondence Address: Frank Pincelli;Patent Legal Staff, Eastman Kodak Company, 343 State Street, Rochester, NY, 14650-2201, US

(21) Appl. No.: 11/853,398

(22) Filed: Sep. 11, 2007

(51) Int. Cl. C03C 15/00

(52) U.S. Cl. 216/60; 216/85

(57) ABSTRACT

Measuring thickness and the rate of change of thickness of a material having a surface while the material is being etched, comprising: illuminating the material with low coherence light, a portion of the which transmits through the material and a portion of which is reflected; etching the material surface and while etching, collecting a portion of the reflected light from each optical interface of the material with a low coherence light interferometer; calculating the thickness and rate of change of thickness of the material or part of the material according to the obtained interferometric data; and storing or displaying the resultant thickness and rate of change of thickness of the material. The present invention provides a unique way of calculating the thermo optic coefficient of a material. This method can be used simultaneously with etching the material so that changes to the etching rate can be made in real time.

### CROSS REFERENCE TO RELATED APPLICATIONS

The present application is related to U.S. Ser. No. 11/262,868, filed Oct. 31, 2005, by Michael Alan Marcus et al., entitled “Measuring Layer Thickness Or Composition Changes”.

### FIELD OF THE INVENTION

The present invention relates to providing physical measurements of the thickness of a material and more particularly relates to measuring the thickness and rate of etching, and composition of such etched material while the material is being etched.

### BACKGROUND OF THE INVENTION

Many micro-electromechanical systems (MEMS) devices, sensors, integrated circuits, and optical and electro-optical elements require controlled removal of materials such as silicon and silicon oxides. A range of etching processes, including dry and wet etching processes, can be used to remove material to produce patterns or useful features. Moreover, many sensors and MEMS devices are required to operate in harsh chemical environments. In these cases, etching of the materials used in the sensors by the chemical environment can lead to device failure. Consequently, measurement of etching of the materials of construction to be used in the device is required. A key aspect of etching processes is monitoring the thickness of the material. The materials can be homogeneous, such as silicon metal, or heterogeneous, such as silicon oxide layers coated on silicon metal substrates. Because of the critical dimensions involved, it is advantageous to be able to accurately measure the material thickness, not only after etching, but also in situ, as the etching occurs. That is, it is desirable to be able to measure material thickness and rate of change of material thickness dynamically. It is also desirable to monitor the composition of the material. This is particularly important for heterogeneous materials where etching can lead to changes in the composition of the material.

There are inherent difficulties that complicate the measurement process in etching processes that make some conventional approaches unworkable for in situ measurement. Some current ways to characterize etching, for example of Si and SiO₂, include quartz crystal microbalance techniques, profilometry, potentiometry, spectroscopic ellipsometry, and spectrophotometric methods (FTIR, UV-Vis)). Quartz crystal microbalance techniques can be used to carry out accurate etching measurements (K. T. Lee, S. Raghavan, “Etch Rate of Silicon and Silicon Dioxide in Ammonia-Peroxide Solutions Measured by Quartz Crystal Microbalance Technique” Electrochemical and Solid-State Letters, vol. 2, 172-174 (1999)). However, quartz crystal microbalance methods like this require that the material to be etched be first coated on the quartz crystal. This is not convenient and limits the application of this method to materials from which suitable coatings on the quartz crystal monitor can be made. Even for materials, which can be coated, the quartz crystal microbalance technique is limited to coatings, which can be prepared in the operating range of the quartz crystal, that is temperatures below 570° C.

Potentiometric methods can be applied to evaluation of in situ etching of materials, notably silicon such as the open circuit method such as that reported by EP Patent Application No. 0725435A2 by Schmidt et al. entitled “Electrochemical Measurements for in-situ Monitoring of Semiconductor Wafer Cleaning Processes”. However, this method provides an indirect measure of material thickness and requires calibration of the potentiometric output, such as the voltage potential, by another means such as spectroscopic ellipsometry. It is also inconvenient because in practice this method requires electrical contacts to be made on the material, such as by vacuum deposition of a metal on a surface of the material to be etched. Furthermore, this method requires use of a reference electrode, which can limit the usefulness of this method. For example, in the etching environment, the electrode can be degraded by the etching solution.

Spectroscopic ellipsometry and methods that use spectrophotometric techniques such as FTIR, UV-VIS and optical emission can be used to perform in situ measurements. U.S. Pat. No. 7,049,156 entitled “System and Method for In-Situ Monitor and Control of Film Thickness and Trench Depth” by A. Kueny describes a method for measuring thickness of a layer using spectral reflectometry and comparing to known models and requires development of complex algorithms for each new material investigated. U.S. Pat. No. 6,888,639 by Goebal et al. entitled “In-Situ Film Thickness Measurement Using Spectral Interference at Grazing Incidence” also describes a reflectance spectroscopic technique but requires measuring at large grazing angles. Both of these techniques are limited to front side applications. In U.S. Pat. No. 6,413,867 by Sarfaty et al., entitled “Film Thickness Control Using Spectral Interferometry”, a further variation of use of spectral reflectance interferometry is described. No. In this method, the observed spectral interference fringes as a function of wavelength are compared to a reference data set using pattern recognition techniques in order to determine when the appropriate etching end point has been reached. This technique does not measure etching rates and the requirement for a reference sample limits its scope of applicability.

U.S. Pat. No. 5,694,207 entitled “Etch Rate Monitoring by Optical Emission Spectroscopy” by Hung et al describes an indirect method of measuring the rate of plasma etching on a silicon wafer by measuring optical emission from the plasma. This method infers etch rates based on concentration of gases in the plasma and is only a front sided measurement.

Another spectroscopic approach is to study changes in the etching environment to infer etching rates of the material. For example, D. Chopra et al. in a paper entitled “In-situ Measurements of Ultrathin Silicon Oxide Dissolution Rates” in Thin Solid Films, Vol. 323, pp 170-173, 1998 uses a chemical probe dissolved in the etchant to enable spectroscopic evaluation of etching rates of silicon oxide. However this requires adding a tracking agent to the etchant and the method is inherently indirect.

The use of laser reflectance reflectometry is described by E. Steinsland et al., “In Situ Measurement of Etch Rate of Single Crystal Silicon”, paper 2D3.12P in Transducers 97, IEEE pages 707-710. This method measures the intensity of light reflected off of a silicon wafer while being etched as a function of time and measures the change in thickness by counting the build up of interference fringes. This technique can provide only relative rate information but not total thickness. Surface roughness on the sample will greatly affect the results of this type of measurement and it is limited in resolution to about 0.1 μm.

All of the above techniques require special view ports in order to protect their optical components from the etching environment. In some cases this is undesirable since it can complicate the etching set-up and adds cost. Moreover, these spectroscopic techniques are limited in their application to optically transparent etching environments. In practice, the signal to noise can be significantly reduced in the etching environment by the presence of optically dense materials such as dyes. Profilometry is not suitable for in situ measurements because it requires removal and manipulation of the sample.

An alternative solution to these limited in situ methods is to use a surrogate “witness plate” that can be subjected to the etching process and removed after a period in order to allow accurate measurement of etching outside the etching environment. For example, the witness plate can be measured outside of the etching environment by spectroscopic ellipsometry. However, such a solution requires space in the etching environment, requires an interface for its removal and reinsertion, introduces additional surface area and waste, and necessitates time delay so that the ability to obtain dynamic measurement data is compromised.

Although the methods described in the above listing may provide some measure of accuracy in determining etching, there is a significant need for improvement. In situ measurement would provide the most highly accurate data for determining the rate of etching, useful in maintaining precision control of the etching process and characterizing the chemical compatibility of the material. There exists a need for an improved method for measuring etching of materials including coated materials.

### SUMMARY OF THE INVENTION

In accordance with the present invention, there is provided a method of measuring the thickness and the rate of change of thickness of a material having a surface while the material is being etched, comprising:

a) illuminating the material surface with low coherence light, a portion of which transmits through the material and a portion of which is reflected;

b) etching the material surface and while etching, collecting a portion of the reflected light from each optical interface of the material with a low coherence light interferometer;

c) calculating the thickness and rate of change of thickness of the material or part of the material according to the obtained interferometric data; and

d) storing or displaying the resultant thickness and rate of change of thickness of the material.

The present invention provides an effective method of measuring the rate of change of thickness of material while the material is being etched.

As a further advantage, the method of the present invention allows real-time monitoring of the etching rate, useful in a control loop that regulates the etch rate.

In another aspect of the present invention, there is provided a method of measuring the thermo optic coefficient of a material comprising:

a) illuminating the material with low coherence light, a portion of which transmits through the material and a portion of which is reflected;

b) heating or cooling the material over a defined time interval;

c) collecting a portion of the reflected light from each optical interface of the material with a low coherence light interferometer at a multiplicity of times within the defined time interval;

d) calculating the optical thickness of the material at the said multiplicity of times according to the obtained interferometric data;

e) monitoring the temperature of the material as a function of time during the defined time interval;

f) calculating the thermo optical coefficient by determining the slope of the change in optical thickness with respect to temperature during the defined time interval; and

g) storing or displaying the thermo optic coefficient of the material.

The present invention provides a unique way of calculating the thermo optic coefficient of a material. This method can be used simultaneously with etching the material so that changes to the etching rate can be made in real time.

### BRIEF DESCRIPTION OF THE DRAWINGS

FIG. 1 is a block diagram showing a first embodiment of a measurement system for performing in-situ low coherence interferometry measurements of material thickness and etching rates during etching;

FIG. 2 shows a block diagram of a second embodiment of a measurement system for performing in-situ low coherence interferometry measurements of material thickness and etching rates during etching;

FIG. 3 shows a block diagram of a third embodiment of a measurement system for performing in-situ low coherence interferometry measurements of material thickness and etching rates during etching;

FIG. 4 shows a block diagram of a fourth embodiment of a measurement system for performing in-situ low coherence interferometry measurements of material thickness and etching rates during etching;

FIG. 5 shows a block diagram of a fifth embodiment of a measurement system for performing in-situ low coherence interferometry measurements of material thickness and etching rates during etching;

FIG. 6 shows an exploded view of an optical probe, and an etching chamber used in the practice of this invention;

FIG. 7 shows an assembled view of the optical probe, and etching chamber, shown in FIG. 6;

FIG. 8 shows a first configuration of a low coherence interferometer used in the practice of this invention;

FIG. 9 shows a second configuration of a low coherence interferometer used in the practice of this invention;

FIG. 10 shows the measurement geometry for low coherence light for a sample containing a substrate and a coating;

FIG. 11 shows a plot of the temperature dependence of the measured optical thickness of a silicon wafer while it is being heated;

FIG. 12 shows a plot of the measured etching rate of a silicon wafer in a commercially available pH 10 buffer at 48.9° C.;

FIG. 13 shows a plot of the measured etching rate of a sheet of borosilicate glass using a 1015 etching solution at 71° C.;

FIG. 14 shows a plot of the measured optical thickness and temperature during etching of a silicon wafer using an opaque dimethylethanolamine buffer containing carbon black (pH 8.45) at various temperatures;

FIG. 15 shows an expanded view of a region of the plot shown in FIG. 14 with temperature corrected values; and

FIG. 16 shows an Arrhenius plot obtained from the data of FIG. 14.

### DETAILED DESCRIPTION OF THE INVENTION

In accordance with the present invention it has been determined that low coherence interferometry can be used to measure etching rates of materials in situ, during the etching process. The methods and apparatus of the present invention are particularly well suited to determine etching rates of homogeneous materials and materials comprised of coated substrates such as coatings on silicon wafers, on glass and on other flat substrates, and to determine the stability of these materials and coatings when subjected to an environment containing etchants.

In the present invention etching processes, which can be monitored by in situ low coherence interferometry, include any process used to remove material. Examples of etching processes include chemical polishes and wet etching processes that use acidic solutions such as hydrofluoric acid (HF) and hydrofluoric acid/nitric acid/acetic acid (HNA) mixtures, and wet etching processes that use basic solutions, such as potassium hydroxide (KOH) solutions and ethylenediamine solutions. Overviews of some wet etching processes used in micromachining applications can be found in S. Wolf and R. N. Tauber, “Silicon Processing for the VLSI Era, Vol. 1, Process Technology,” Lattice Press, Sunset Beach, pp 514-538, 1986; D. L. Kendall, R. A. Shoultz, “Wet Chemical Etching of Silicon and SiO₂, and Ten Challenges for Micromachiners,” in Microlithography, Micromachining, and Microfabrication, Vol. 2, P. R. Choudhury, Ed., SPIE Optical Engineering Press, London, 1997, pp 41-97. In addition, low coherence interferometry can be used to monitor the stability of materials in fluid management systems in which the fluids can etch the surfaces of the materials in contact with the fluids.

Additional examples of methods for removing material include dry etching processes, such as reactive ion etching (RIE), deep reactive ion etching (DRIE), plasma-etching, ion milling, and sputtering. Overviews of these dry etching processes can be found in S. Wolf and R. N. Tauber, “Silicon Processing for the VLSI Era, Vol. 1, Process Technology,” Lattice Press, Sunset Beach, pp 539-585. In addition to dry- and wet-etching, low coherence interferometry can also be used to measure material removal during mechanical material removal processes, like chemical mechanical polishing (CMP), used for example in the fabrication of semiconductor integrated circuits. These examples of etching processes, such as wet and dry etching and CMP, which can be monitored by in situ low coherence interferometry, are meant to be instructive and not limiting.

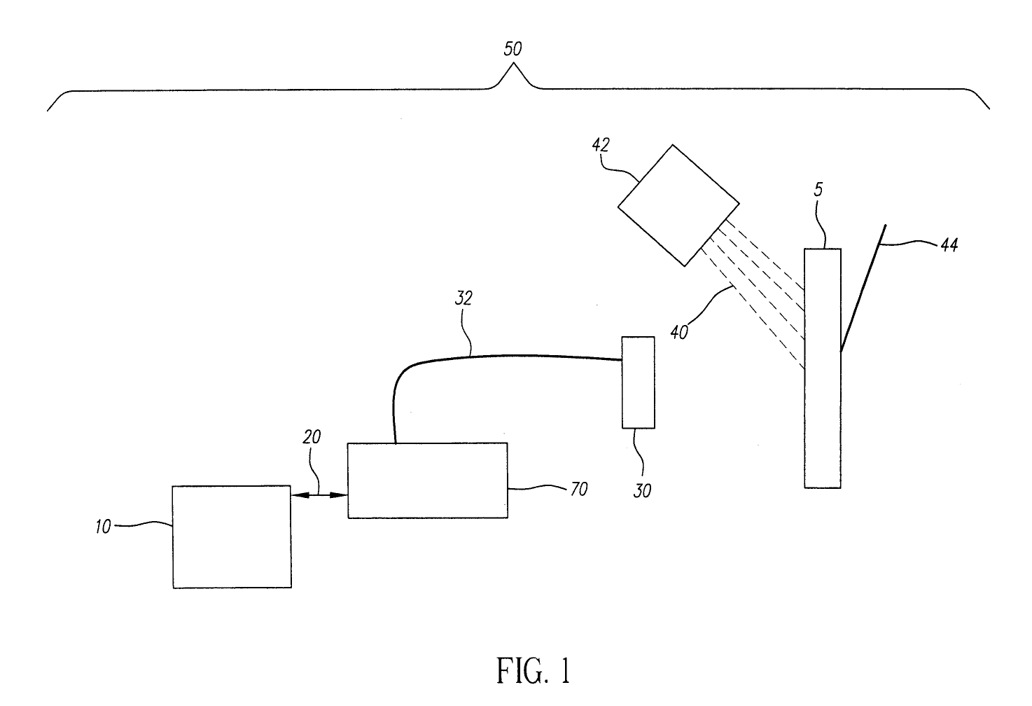

FIG. 1 shows a block diagram of a first embodiment of a measurement system 50 for performing in-situ low coherence interferometry measurements of material thickness and etching rates during etching. The measurement system 50 includes a low coherence interferometer 70, which measures the thickness and change of thickness with time of a sample of material 5 as it is being etched with etchant 40, from an etchant source 42. An optical probe 30 transmits light to the sample 5 and collects reflected light from each optical interface in the sample is coupled to interferometer 70 by the sample optical fiber 32. The low coherence interferometer 70 is controlled by a computer, instrument control and display unit 10 through a bidirectional communication interface 20. Temperature measurement means 44 is also usually included in the measurement system 50 in order to monitor the temperature of the material 5 during etching. The configuration of measurement system 50 shown in FIG. 1 is an example of a front-sided etching geometry since the surface being etched is towards the measurement instrument.

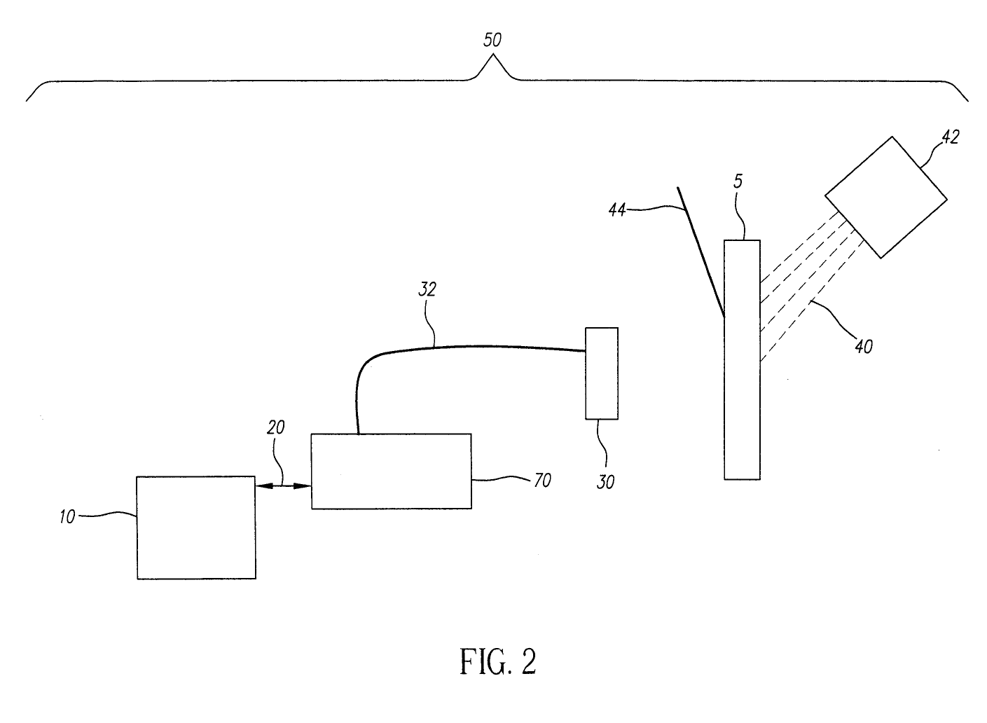

FIG. 2 shows a block diagram of a second embodiment of a measurement system 50 for performing in-situ low coherence interferometry measurements of material thickness and etching rates during etching. The configuration of the measurement system, 50 shown in FIG. 2 is an example of a back-sided etching geometry since the low coherence light from the interferometer 70 must pass through the material 5 before reaching the surface being etched. All of the components of the second embodiment are the same as in the first embodiment shown in FIG. 1.

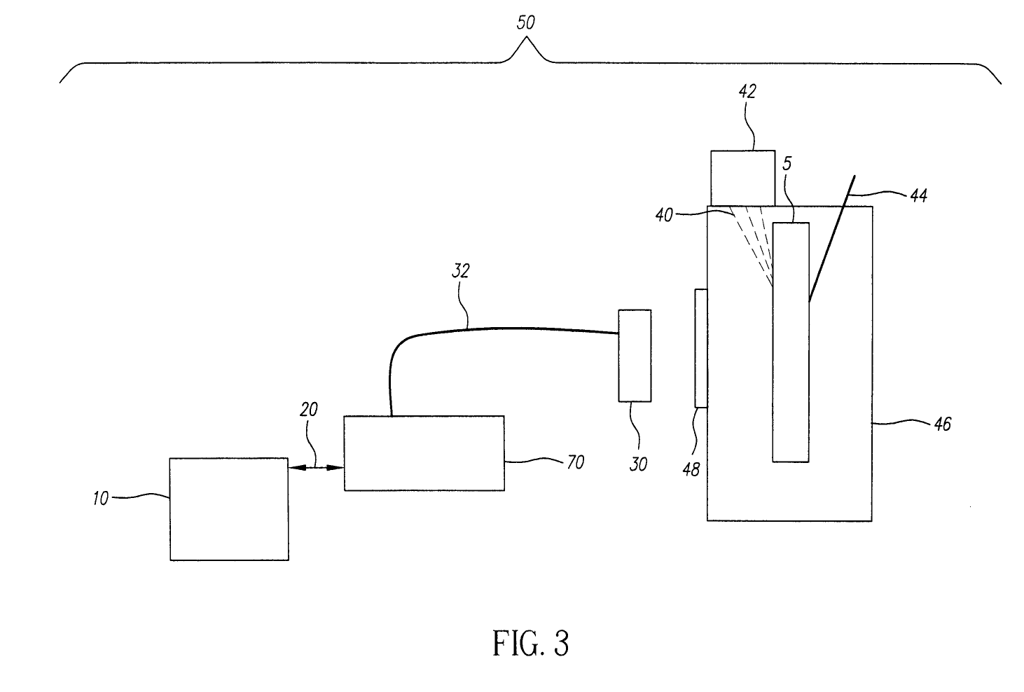

FIG. 3 shows a block diagram of a third embodiment of a measurement system 50 for performing in-situ low coherence interferometry measurements of material thickness and etch rates during etching. This embodiment is also a front-sided measurement as in the first embodiment shown in FIG. 1 and includes all of the same parts. In addition to all the parts in the first embodiment, this embodiment includes an etching chamber 46 in which the material being etched 5 is held in place by a suitable mounting means (not shown). A light transmissive window 48 is installed facing the optical probe 30 in order to allow light from the optical probe to pass through the window 48 and reflect from the optical interfaces of the sample 5. The window 48 can also function as a reference surface for measuring etching rates if the sample is not optically transparent at the measurement wavelength.

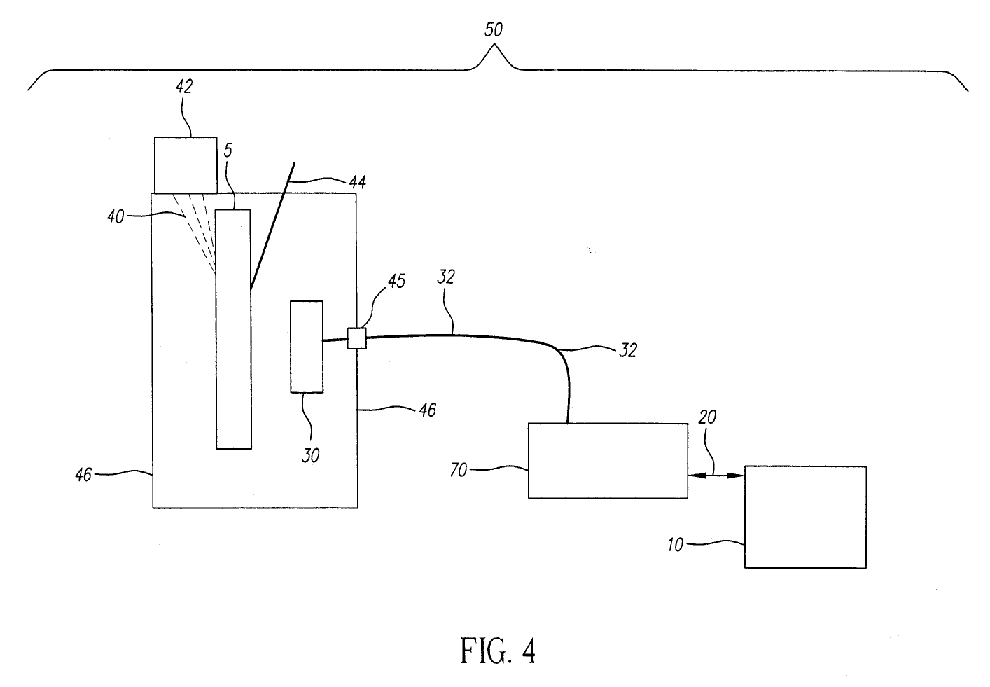

FIG. 4 shows a block diagram of a fourth embodiment of a measurement system for performing in-situ low coherence interferometry measurements of material thickness and etch rates during etching. In this embodiment the optical probe 30 is housed inside the etching chamber 46. A fiber optic chamber feedthrough 45 is used to couple light from the sample optical fiber 32 to the optical probe 30. This is also an example of a back-sided measurement.

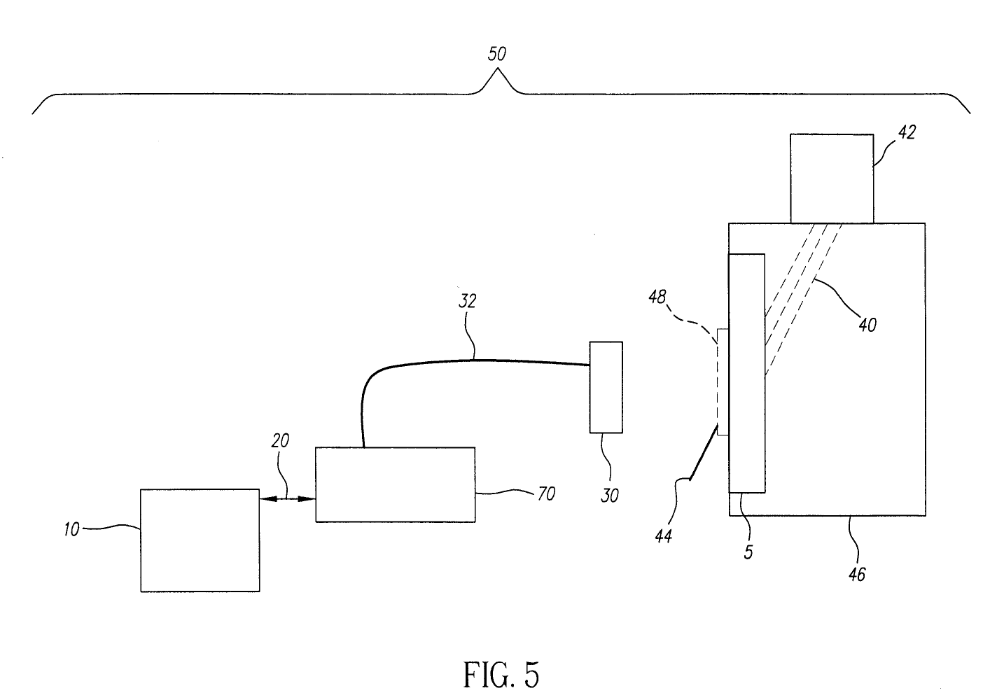

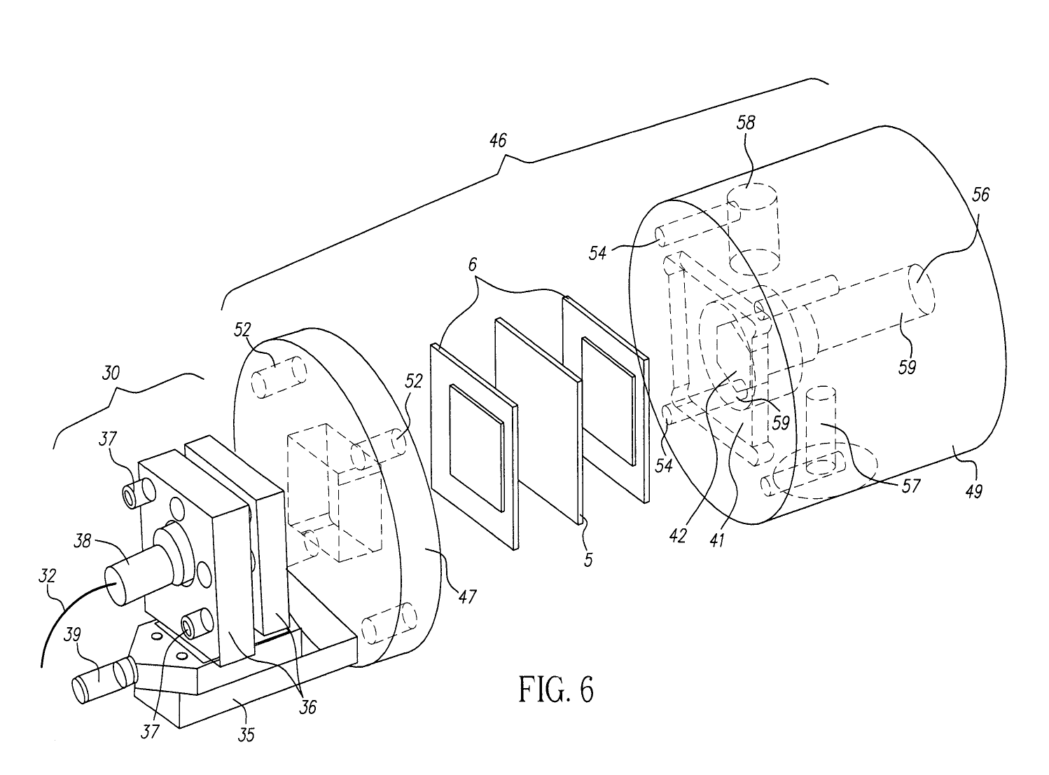

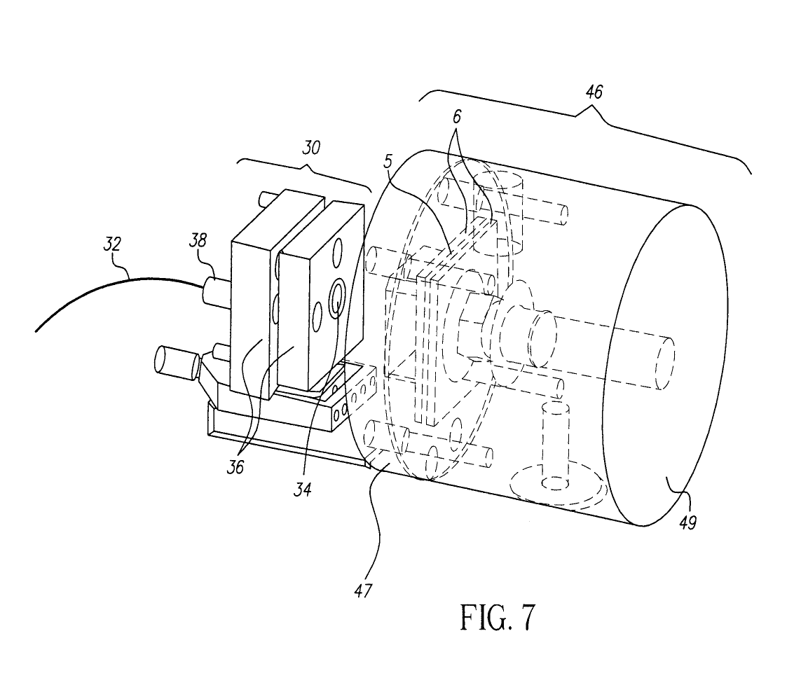

FIG. 5 shows a block diagram of a fifth embodiment of a measurement system for performing in-situ low coherence interferometry measurements of material thickness and etching rates during etching. This embodiment is also a back-sided measurement with the optical probe outside of the chamber. An optional window 48 may be installed in a wall of the chamber 46. In some cases the sample can take the place of the window as shown in the embodiment shown in FIGS. 6 and 7.

FIG. 6 shows an exploded view of an optical probe, and an etching chamber used in the practice of this invention using the fifth embodiment described in FIG. 5. FIG. 7 shows an assembled view of the apparatus shown in FIG. 6. In this apparatus the optical probe 30 is mounted to the chamber 46 at a chamber probe mount 47 attached to an optical probe mount 35. The optical probe 30 includes a Gimbal mount 36 with angular positioning means 37 and focusing means 39 which hold the lens (not shown) in place and is attached to the optical probe mount 35. Optical fiber connector 38 connected to the sample optical fiber 32 attaches to the Gimbal mount 36 which adjusts the direction that light coming out of sample optical fiber 32 so that it is normal to the sample of material 5 and the focusing means 39 adjusts the depth of the probe so that light is focused on the material 5. The etching chamber 46 includes a chamber housing 49, an etchant inlet 56 an etchant outlet 58, and an etchant cavity 59, which together define the etchant flow path. An optional etchant jet assembly 42 may also be installed in the etchant flow path to provide focused etchant material onto the surface of the material 5 being etched at the location of interferometer measurement. The material 5 is placed between a pair of gaskets 6 which fit snuggly and creates a leak tight seal between the chamber sample pocket 41 and the chamber probe mount 47 of the etching chamber 46. Sealing is accomplished by threading bolts (not shown) through the boltholes 52 of the chamber probe mount 47 into the bolt receptacles 54 of the chamber housing 49 to form a pressure tight seal. The gaskets 6 are designed to seal at the edges and leave open windows for light from the interferometer to interact with the sample and to allow etchant to hit the sample in the interferometer measurement region of the sample. The chamber housing 49 also includes a temperature probe receptacle 57 to receive a temperature measurement device, which can be used to measure the temperature of the etchant and/or sample during measurement of etching rates.

FIG. 7 shows an assembled view of the optical probe, and etching chamber, shown in exploded view in FIG. 6. The sample lens 34 is mounted in the Gimbal mount 36 and is facing the sample 5.

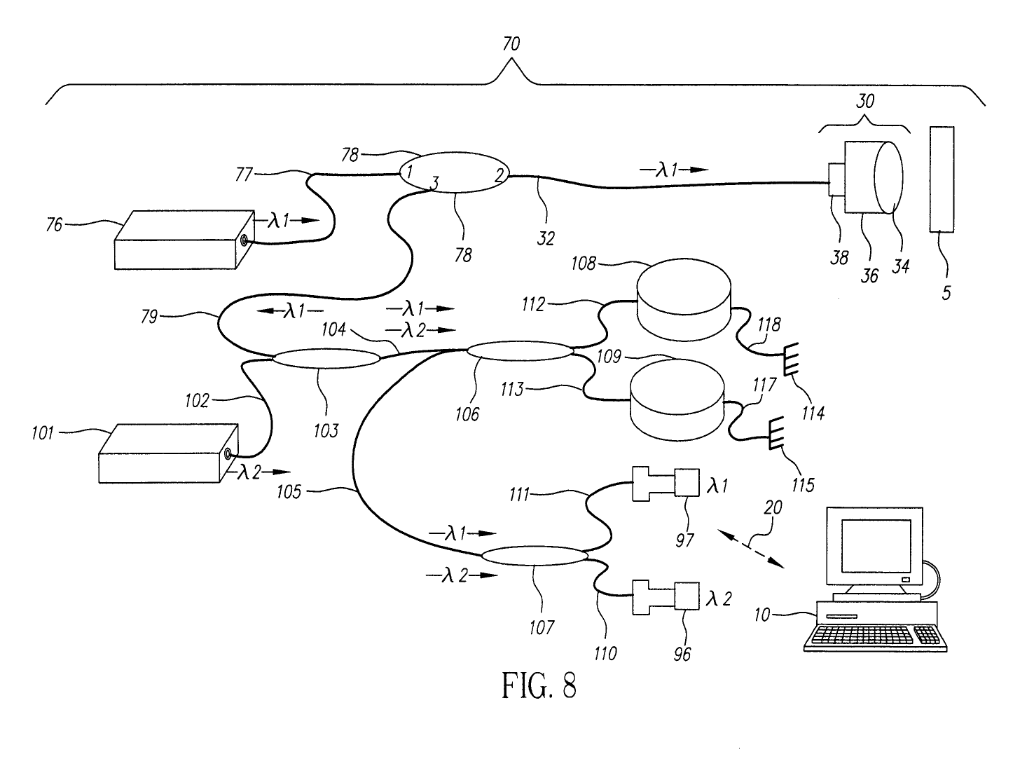

FIG. 8 shows a first embodiment of a low-coherence interferometer 70 used in the practice of this invention. Low-coherence light as used in this embodiment is defined as light having a short coherence length typically on the order of about 8 to 20 microns. The configuration shown in FIG. 8 is a dual fiber interferometer, which combines a low coherence light interferometer used to measure the sample, with a laser interferometer which is used to provide a constant interval distance scale during measurement as described in commonly assigned U.S. Pat. No. 5,596,409 entitled “Associated Dual Interferometric Measurement Method for Determining A Physical Property of an Object” and in U.S. Pat. No. 5,659,392 entitled “Associated Dual Interferometric Measurement Apparatus for Determining a Physical Property of an Object” both to Marcus et al. This first embodiment of a low-coherence interferometer is an example of optical autocorrelation geometry since the sample is placed at the input of the interferometer and the various optical interfaces of the sample interfere with each other. The autocorrelation geometry has the advantage that the sample probe arm is portable and can be of any practical path length up to a few km long without the need to match its path length with that of a reference arm. Also any changes in the environment of the fiber leading to the sample location will be isolated from interference effects at the sample end.

All of the fibers in the apparatus shown in FIG. 8 are single mode fibers and they can also be polarization maintaining fibers if desired. Low coherence light from a broadband light source 76 with a central wavelength λ₁ such as a 1300 nm broadband SLED is directed to sample 5 through a broadband source optical fiber 77 into a fiber optical circulator 78 passing from port 1 to 2 into sample optical fiber 32. The fiber optical circulator 78 directs the light from port 1 to port 2 and light from port 2 to port 3 with excellent isolation. Alternatively the circulator 78 can be replaced with a standard 1 by 2 fiber optic coupler, but this is not as efficient. The sample optical fiber 32 is connected to the optical probe 30 by the optical fiber connector 38 which is preferable an FC/APC connector. The optical probe 30 includes a probe mount such as a Gimbal mount 36 with a lens 34 attached to the probe mount 36. The probe also includes a mounting means (not shown). During operation low coherence light from broadband light source 76 transmitted through sample optical fiber 32 is coupled to optical probe 30 and is focused onto the sample 5 by lens 34. A portion of the low coherence light reflected from all of the optical interfaces in the sample 5 is collected by optical probe 30 and returns back down sample optical fiber 32 into port 2 and out port 3 of fiber optic circulator 78, and into interferometer input optical fiber 79. Light passing through interferometer input optical fiber 79 passes through a wavelength division multiplexer (WDM) 103 and is input into an all fiber Michelson interferometer. Light coming from coherent source 101 with wavelength λ₂ which is preferably a temperature stabilized single mode laser diode operating at a wavelength of about 1550 nm is coupled to coherent source optical fiber 102. Light passing through coherent source optical fiber 102 is coupled into the WDM 103 which functions to combine the low coherence light traveling down interferometer input optical fiber 79 with the coherent light traveling down coherent source optical fiber 102. The combined light travels down the WDM exit optical fiber 104 and is input into a 2 by 2 fiber optic coupler 106 preferably with a 50/50 splitting ratio. The output of coupler 106 is split into a pair of interferometer arm optical fibers 112 and 113, which make up the two arms of the Michelson interferometer. Fibers 112 and 113 are coiled around a pair of piezoelectric modulators 108 and 109 respectively, which are operated in a push-pull fashion to alternately change the effective optical path length along optical fibers 112 and 113. Piezoelectric modulators 108 and 109 are driven with sine or triangle waveforms preferably at frequencies in the range of 10 Hz to 3 kHz and can generate path length differences of up to 10 mm. Mirrors 114 and 115, preferably Faraday rotator mirrors, are coupled to the distal ends of optical fibers 112 and 113 to reflect light back into the 50/50 coupler 106. The returning light beams from fibers 112 and 113 interfere with each other and the coupler 106, modulators 108 and 109, fibers 112 and 113 and mirrors 114 and 115 form an all fiber Michelson interferometer. The interfering low-coherence light from the different optical interfaces of the sample 5 and the interfering light from coherent source 101 returning from 50/50 coupler 106 travels along a detection optical fiber 105 and is split into two wavelength components by second wavelength division multiplexer (WDM) 107. The laser light coming out of second WDM 107 travels down a coherent light detection optical fiber 110 into a laser interference detector 96 and the low-coherence light coming out of WDM 107 travels down low coherence detection optical fiber 111 into low-coherence light interference detector 97.

Data acquisition, analysis and display of data are performed utilizing a computer, instrument control and display unit 10 containing appropriate hardware, such as National Instrument data acquisition cards. A bidirectional communication interface 20 is used to control data flow from the interferometer to the computer by sending appropriate control signals to the interferometer 70 including control of piezoelectric modulators 108 and 109, monitoring the detector signals from detectors 96 and 97 and providing data triggering signals. The periodicity of the laser light is utilized to track the optical distance that the low-coherent light interferometer modulators scan. In our examples signal processing and data analysis routines are run under a Labview program development environment (available from National Instruments) running on computer, instrument control and display unit 10 to analyze the low-coherent light interferograms resulting from reflections at optical interfaces in the sample.

The laser 101 in the interferometer is utilized to track the distance the optical path has changed during the push pull operation of piezoelectric modulators 108, 109 in the all fiber interferometer shown in FIG. 8. Constructive interference of the laser interferometer occurs when the path lengths of the interferometer are the same or every time they differ by nλ/2. A threshold value on the laser signal is utilized to provide a sequence of data acquisition trigger signals at constant distance intervals for collecting interferometric data from the low-coherence light interferometer. When the threshold value is set to 0, the locations of the zero-crossings of the laser signal are used which for a 1550 nm laser diode provide a constant distance measurement interval of 0.3875 μm. Thus, the purpose of the laser interferometer is to track the distance the optical path in the interferometer has changed while the low-coherence light interferometer is collecting data from the sample.

For the low-coherence broadband light source 76, constructive interference occurs when the path lengths of the two arms in the interferometer are equal within a few coherence lengths. In order for constructive interference to occur, light must be reflected back into the interferometer from the sample 5. This will occur at each optical interface in the sample 5. The distance between adjacent interference peaks represents the optical thickness (group index of refraction (n) times the physical thickness) of the materials making up the sample 5.

Since the instrument uses a stabilized laser light source for providing constant distance interval measurements, the instrument measures absolute optical path distance defined as (n) multiplied by physical thickness. The measurement configuration of the interferometer is the optical autocorrelation mode, in which light reflecting from the sample is input to both arms of the Michelson interferometer. In the autocorrelation mode, light reflecting from the sample is made to interfere with itself, and both arms of the interferometer see reflections from all of the optical interfaces in the sample. As the path lengths of the two arms of the interferometer are changed, a series of interference peaks are observed, indicating the optical path differences between adjacent optical interfaces. The self-correlation condition occurs when the two path lengths of the Michelson interferometer are equal, in which case all optical interfaces in the sample interfere constructively. The measured distance between the largest peak, at zero path length difference, and the first set of adjacent peaks is the shortest optical path difference in the sample.

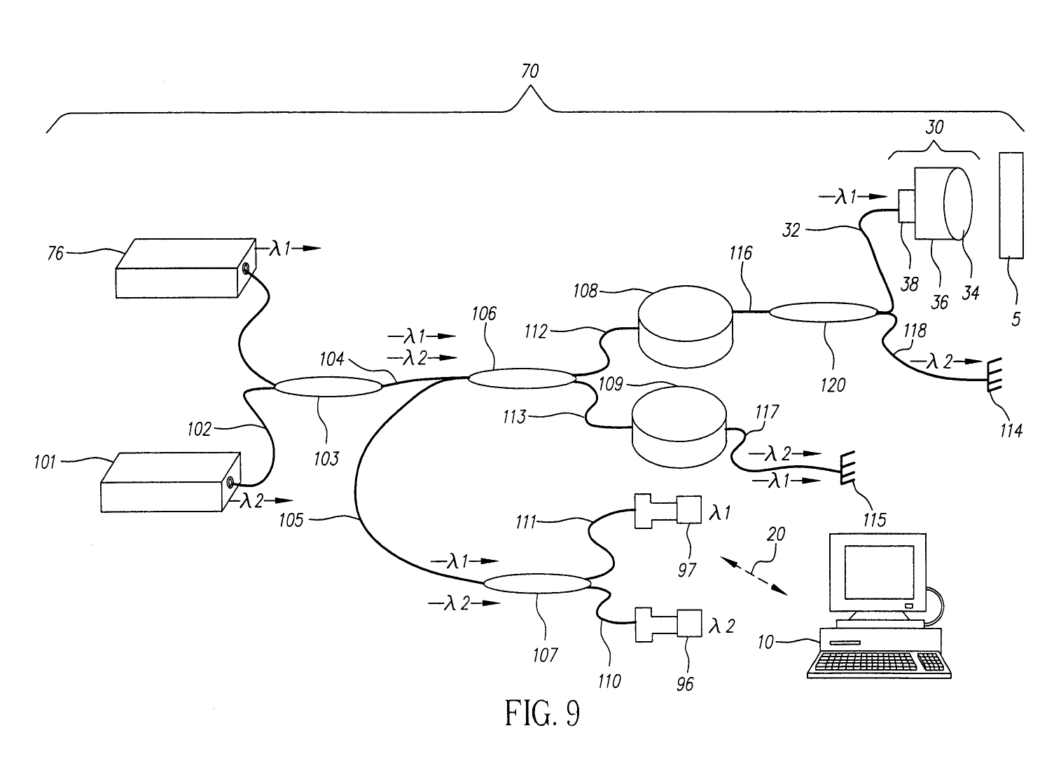

An alternate configuration for an all fiber based interferometer is shown in FIG. 9. Instead of being an autocorrelation based instrument as shown in FIG. 8 this configuration is a standard Michelson configuration in which the sample is placed in one of the arms of the interferometer. A reference laser 101 is included to provide constant distance interval sampling as described above. All parts serve the same function as in the description for FIG. 8 above with the exception of an addition of a reference optical fiber 116 coupled to an additional WDM 120 which is used to block the laser light from going to the sample and to separate the coherent source signal from the sample low coherence signal. The coherence source signal is made to travel down reference optical fiber 118 and is incident on stationary mirror 114. The low-coherence light travels down sample optical fiber 32, through optical probe 30 and reflected light from each optical interface of sample 5 is sent back down optical fiber 32. Light from both light sources travels down optical fiber 117 and is reflected by mirror 115. In order for the interferometer to function, the optical path lengths of travel to mirror 115 and sample 5 must be the same within the path length excursion of the interferometer.

### Calculation Methods and Results

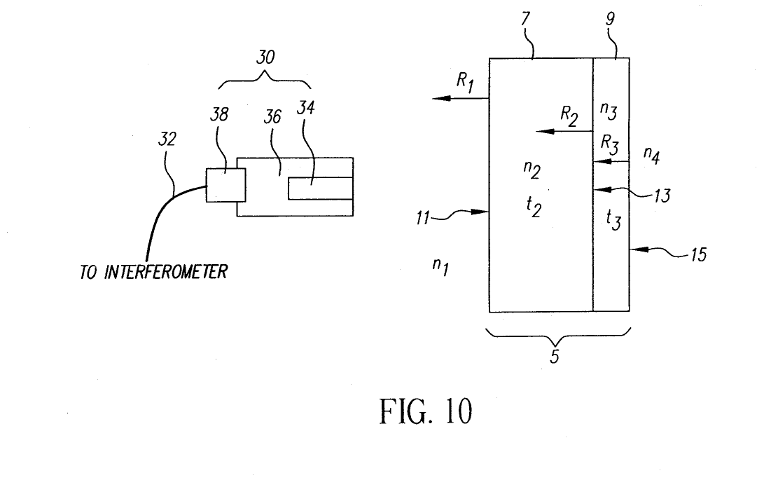

It is instructive to describe how the expected interferometric signals are derived and how the calculations are performed. It is assumed that there is minimal absorption and scattering in the material so that peak intensities are determined by reflection and transmission and index of refraction. Assume light intensity Iₒ is incident on the 2 layer material structure shown in FIG. 10. The index of refraction is n₁ between the lens 34 of optical probe 30 and the first surface 11 of sample 5 composed of a substrate 7 of thickness t₂ and index of refraction n₂ and a coating 9 of thickness t₃ and index of refraction n₃. The index of refraction behind the coating 9 is n₄. There are three optical interfaces 11, 13 and 15 with reflection intensities R₁, R₂ and R₃ with reflection intensities given by

$${R}_{1} = \frac{{( {n}_{2} - {n}_{1} )}^{2}}{{( {n}_{2} + {n}_{1} )}^{2}} , {R}_{2} = \frac{{( {n}_{3} - {n}_{2} )}^{2}}{{( {n}_{3} + {n}_{2} )}^{2}} , {R}_{3} = \frac{{( {n}_{4} - {n}_{3} )}^{2}}{{( {n}_{4} + {n}_{3} )}^{2}} \qquad ( 1 )$$

Assuming there is no absorption and no scattering in the materials it can be assumed that the intensity on the first interface is Iₒ the incident light intensity. The light intensity of the light transmitted into the top layer of the material L₁ is given by

L₁=Iₒ(1−R₁) (2)

Similarly the light intensity transmitted into the second layer L₂ is given by

L₂=L₁(1−R₂)=Iₒ(1−R₁)(1−R₂) (3)

And the light intensity being transmitted past the third optical interface L₃ is given by

L₃=L₂(1−R₃)=Iₒ(1−R₁)(1−R₂)(1−R₃) (4)

In an interferometer which is set up in an optical autocorrelator configuration, the light that comes back from each optical interface interferes with light from each of the other optical interfaces. The signal coming back to the interferometer from the first optical interface S₁ is given by

S₁=IₒR₁ (5),

the signal coming back to the interferometer from the second optical interface S₂ is given by

S₂=IₒR₂(1−R₁)² (6)

and the signal coming back to the interferometer from the third optical interface S₃ is given by

S₃=IₒR₃(1−R₁)²(1−R₂)² (7).

For the interfaces in FIG. 10, intensity above the zero-crossing amplitude will be S₁²+S₂²+S₃², the intensity of the non zero-crossing peak occurring at position n₂t₂ from the origin will be S₁S₂, and the intensity of the non zero-crossing peak occurring at position n₃t₃ from the origin will be S₂S₃. There will also be a third peak at location n₂t₂+n₃t₃ with intensity S₁S₃.

The complete interferogram for this type of sample is given by

$$S ( x ) = ( {S}_{1}^{2} + {S}_{2}^{2} + {S}_{3}^{2} ) {e}^{- {kx}^{2}} cos ( \frac{4 π x}{λ} ) + \\ {S}_{1} {S}_{2} ( {e}^{- {k ( x - {n}_{2} {t}_{2} )}^{2}} cos ( \frac{4 π ( x - {n}_{2} {t}_{2} )}{λ} ) + {e}^{- {k ( x + {n}_{2} {t}_{2} )}^{2}} cos ( \frac{4 π ( x + {n}_{2} {t}_{2} )}{λ} ) ) + \\ {S}_{2} {S}_{3} ( {e}^{- {k ( x - {n}_{3} {t}_{3} )}^{2}} cos ( \frac{4 π ( x - {n}_{3} {t}_{3} )}{λ} ) + {e}^{- {k ( x + {n}_{3} {t}_{3} )}^{2}} cos ( \frac{4 π ( x + {n}_{3} {t}_{3} )}{λ} ) ) + \\ {S}_{1} {S}_{3} ( {e}^{- {k ( x - {n}_{3} {t}_{3} - {n}_{2} {t}_{2} )}^{2}} cos ( \frac{4 π ( x - {n}_{3} {t}_{3} - {n}_{2} {t}_{2} )}{λ} ) + {e}^{- {k ( x + {n}_{3} {t}_{3} + {n}_{2} {t}_{2} )}^{2}} cos ( \frac{4 π ( x + {n}_{3} {t}_{3} + {n}_{2} {t}_{2} )}{λ} ) ) \qquad ( 8 )$$

where λ is the central wavelength of the light source and k and the rest of the relationships are derived below.

A treatment of interference of partially-coherent light is found in Fundamentals of Photonics, 1991 by B. Saleh and M. Teich. When two partially-coherent light beams interfere, the intensity of the combined beam I(x) as a function of distance x is given by:

I(x)=Iₛ+Iᵣ+2\sqrt{IₛIᵣ}|gₛᵣ(x)|cos φ(x) (9)

where Iₛ and Iᵣ are the intensities of the individual light beams, gₛᵣ(x) is the normalized mutual coherence function and φ(x) is the phase difference between the two light waves. For NIR SLED light sources, the coherence function is Gaussian as a function of distance. For the case where the sample and reference beams are mutually coherent at location xₒ, the third (interference) term in equation 9 called S(x) can be written as:

$$S ( x ) = {I}_{o} {e}^{- {k ( x - {x}_{o} )}^{2}} cos ( \frac{4 π ( x - {x}_{o} )}{λ} ) \qquad ( 10 )$$

where k is a constant which is related to the source coherence length. For a Gaussian distribution, the source coherence length (L_{C}) is given by the expression:

$${L}_{C} = \frac{2 ln 2 {λ}^{2}}{πΔλ} \qquad ( 11 )$$

where Δλ is the source spectral bandwidth. The coherence length defines the full width at half maximum of the Gaussian function in Equation 2. When x−x_{O}=L_{C}/2 the amplitude of the normalized Gaussian function=½. The value of k, which satisfies this relationship, is

$$k = \frac{4 ln 2}{{L}_{C}^{2}} = \frac{{π}^{2} {Δλ}^{2}}{ln 2 {λ}^{4}} . \qquad ( 12 )$$

For a 1300 nm source with a 60 nm bandwidth, the coherence length is calculated to be 12.429 μm and k=1.794747×10¹⁰/m².

Of central importance for signal processing is the development of a true peak location algorithm. The goal is to find the true envelope center of an interferogram (a Gaussian function times a cosine function) when the data are not sampled at the location of the true Gaussian maximum. This must also be performed in the presence of noise from the environment. A variety of alternatives were evaluated including use of beats from multiple wavelength sources, or choice of sampling rate, moment calculations, Gaussian peak analysis, up-conversion, envelope detection, and Hilbert Transform method and Fourier transform phase analysis. The Fourier transform phase analysis technique enables calculating the thickness of thin organic films coated on either silicon or glass substrates in the range from 10 Angstroms (1 nm) up to a few microns in thickness. The Fourier transform phase analysis technique is based on applying the Shift Theorem to a discrete Fourier transform data set. An article by B. Danielson and C. Boisrobert, entitled “Absolute Optical Ranging Using Low Coherence Interferometry”, Applied Optics, 30, 2975, 1991 describes this approach. As taken from R. Bracewell, The Fourier Transform and its Applications, Second Edition, McGraw Hill Book Company, New York, 1978, the Fourier Shift Theorem can be stated as follows:
If f(x) has the Fourier Transform F(s), then f(x−a) has the Fourier Transform e^{-2πias}F(s).
   The Fourier Transform F(s) of the function f(x) is given by:

F(s)=∫_{-∞}^{∞}f(x)e^{-2πixs}dx (13)

where s is the frequency variable and x is the position coordinate. The Fourier Transform shift theorem can be written as:

∫_{-∞}^{∞}f(x−a)e^{-2πixs}dx=e^{-2πias}F(s) (14)

where a is the shift in the x coordinate. If δx is the sampling distance interval, P the calculated phase slope per point in the FFT centered around the frequency fₒ of maximum magnitude in the FFTs power spectrum, and N the number of points in the FFT, then it can be shown that:

$$P = \frac{2 π a}{N δ x} . \qquad ( 15 )$$

The spatial frequency fₒ is calculated from the expression:

$${f}_{o} = \frac{4 ( \frac{N}{2} - 1 ) δ x}{λ} . \qquad ( 16 )$$

In order to use the phase slope algorithm, an initial guess is made as to the x axis location of each of the interferogram peaks. This is done by choosing the location of the absolute value of the maximum amplitude of each of the peaks indicating optical interfaces in the interferogram as the location of the initial guess. A 256 point subset centered around this initial guess is taken and the first 128 points shifted to the end of the 256 point data subset are taken such that the most intense interferogram points are located at the beginning and end of this subset. To reduce noise and improve precision, data points in the middle of this array are set equal to zero (zero filling). The number of zero-filled points is dependent upon the bandwidth of the light source. For a 1550 nm laser and 1300 nm SLED with 50 nm bandwidth, we typically zero fill the central 140 points of the shifted interferogram. The complex FFT of the zero-filled data array is taken and the resulting FFT values are transformed to polar coordinates (magnitude and phase). The center spatial frequency of the FFT is determined by locating the array index value corresponding to the data point having the maximum value of the magnitude spectrum. This frequency is checked for validity based upon expected frequency values obtained from equation (16). The center spatial frequency of the FFT is verified by determining if it falls within the acceptable range, and the phase slope calculation is performed by performing a linear least squares fit on the phase around the points centered on spatial frequency fₒ. Phase unwrapping is required if the phase angle exceeds the range from −π to +π. The phase measured at fₒ is used in equation (15) to calculate the true location of the peak by determining the shift δx from the initial guess location a. The distance between each set of adjacent peaks, gives the optical thickness of the substrate-plus-coating layer at the time the peaks are measured. This process is repeated during an entire etching rate monitoring sequence. In order to determine the thickness divide the measured optical thickness by the index of refraction of the layer material.

In order to apply using low-coherence interferometry for monitoring the rate of change of thickness during in-situ etching the thickness is monitored as a function of time. The rate of change of thickness of the layer is determined by using the peak locations of adjacent maxima determined at known different times, a first time τ₁ and at a second time τ₂, by the interferometer to measure total optical path which corresponds to the optical thickness of the substrate and the layer and subtracting the optical thickness of the substrate plus layer at the known different times and dividing by the difference in the known times (τ₂-τ₁) to determine the rate of change in the optical thickness of the layer. This corresponds to taking the derivative of the change in thickness as a function of time.

The measured optical thickness of a material will also change with temperature due to thermal expansion and the thermo optical effect. The observed temperature dependence is given by the thermo optic coefficient of temperature

$$\frac{d ( nt )}{d T}$$

given by

$$\frac{d ( nt )}{d T} = n \frac{d t}{d T} + t \frac{d n}{d T} = t ( n α + \frac{d n}{d T} ) \qquad ( 17 )$$

which is the sum of two terms where α is the thermal coefficient of expansion of the material and dn/dT is the change of group index of refraction with temperature. Note that the complete thermo optic coefficient is not a constant and is proportional to the thickness of the sample as shown in equation (17). It is also dependent on the temperature range since dn/dT will also depend on temperature. In silicon, there is a slight increase in dn/dT with temperature (see G. Cocorullo et al, Appl. Phys. Lett., Vol. 74, No. 22, 31 May 1999 entitled “Temperature dependence of the thermo optic coefficient in crystalline silicon between room temperature and 550 K at the wavelength of 1523 nm”. As shown in Example 1 low coherence interferometry can be used to measure the thermo optic coefficient of a material directly without the need of independently measuring the thermal coefficient of expansion and the change of group index of refraction with temperature. In Example 5, etching data have been corrected using the thermo optic coefficient.

In the examples shown below the interferometer shown in FIG. 8 was operated at a measurement rate of 200 Hz. Temperature was measured with thermocouples

### EXAMPLE 1

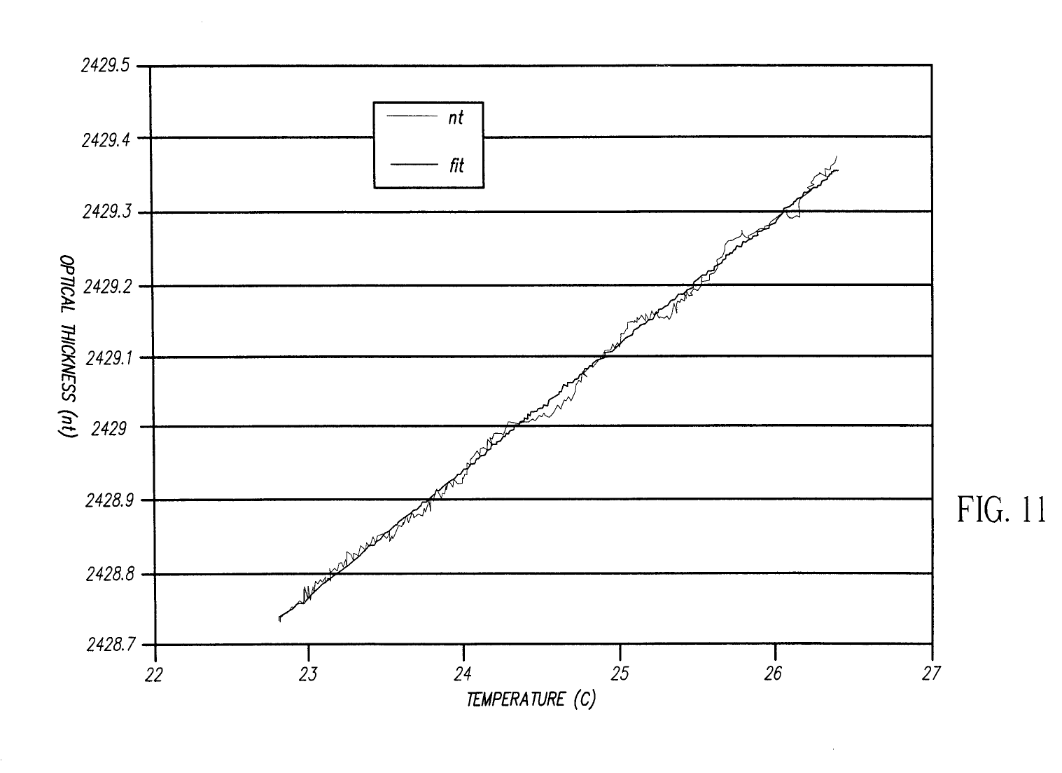

This example shows the effect of temperature on optical thickness measured by low coherence interferometry using the apparatus described in FIG. 8. FIG. 11 shows a graph of measured optical thickness as a function of temperature for a 26.6 mm on a side square coupon (709.7 sq mm) of silicon mounted in the fixture shown in FIGS. 6 and 7. The temperature ramp was 10° C. per hour. The fit of the data shown in FIG. 11 was obtained from a regression analysis of the raw data using the relationship shown in equation (17). The best fit data is n=3.49749, tₒ=694.420 μm, α=4.15E-06/K and dn/dT=2.37E-04/K where to is the initial thickness. Since the thermo optic coefficient of silicon is approximately 2 orders of magnitude larger than typical glass substrates when determining etching rates of silicon it is desirable to measure temperature along with thickness to study dissolution effects in real time using low-coherence interferometry.

### EXAMPLE 2

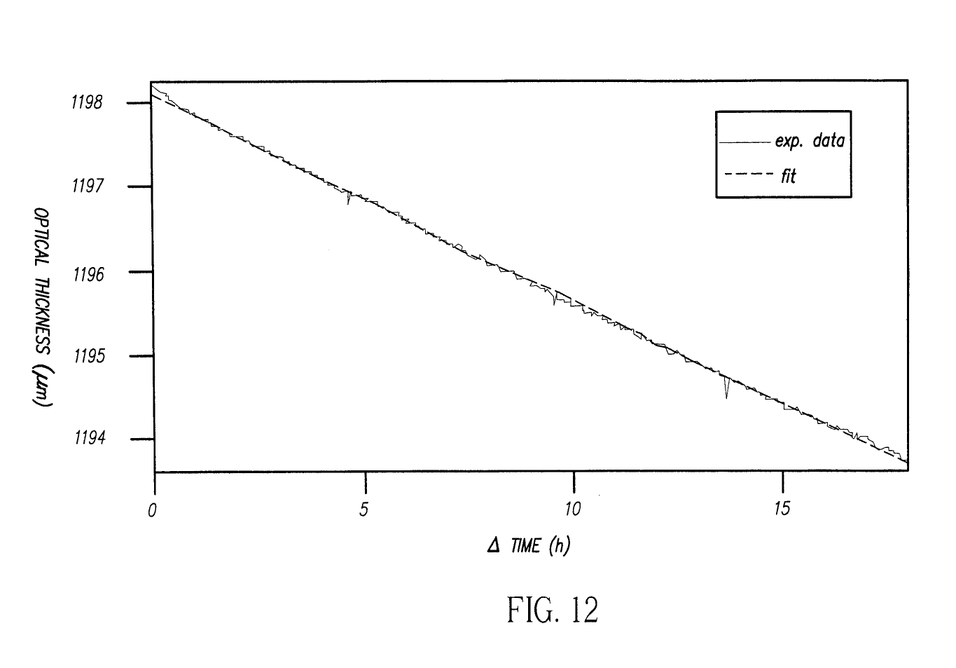

This example shows how low coherence interferometry has been implemented to measure in situ etch rates for a homogeneous material, in this case silicon. A silicon coupon in the 100-orientation (Si(100)) (709.7 sq mm, 0.35 mm thick) polished on both sides was mounted in the fixture shown in FIG. 6, with the fixture mounted in an oven. The position (lateral, vertical, and angular) of the interferometric probe (30 in FIG. 6) was adjusted to obtain signals from the optical interfaces of the silicon. The etching solution (pH 10 buffer obtained from Ricca Chemical Co., experimental pH 10.06) was supplied from a reservoir of etching solution suspended in a constant temperature bath. A recirculation system was used to introduce the etchant into the etching chamber. The recirculation system was comprised of PTFE and stainless steel tubing, a pump and controller, needle valves to regulate pressure and flow, and pressure gauges. In this experiment, the pressure was maintained at atmospheric pressure. The temperature of the etching environment was set to 48.9° C. by regulating the temperature of the constant temperature bath and the oven. The progress of etching of the silicon was followed by low coherence interferometry. The optical thickness data measured by low coherence interferometry are shown in FIG. 12. From a linear fit of the trace obtained from in situ monitoring of the optical thickness (fit shown in FIG. 12, slope=244.8 optical nm/h) divided by the refractive index of silicon (3.4975), the etch rate for the silicon coupon in the pH 10 buffer was determined to be 70 nm/h.

### EXAMPLE 3

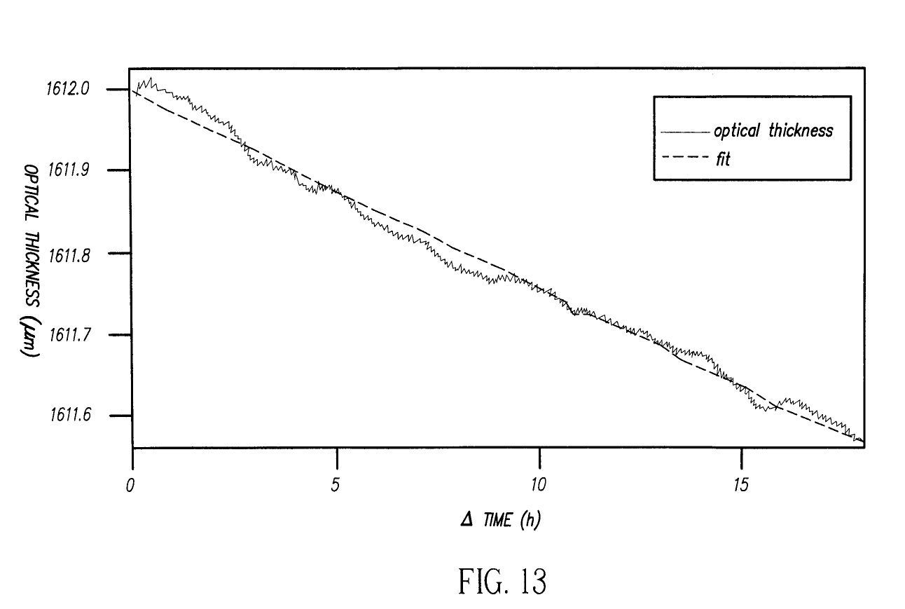

This example shows how low coherence interferometry can be used to measure in situ etch rates for a homogeneous material, in this case borosilicate glass. A borosilicate glass coupon (709.7 sq mm, 1.1 mm thick) was mounted the fixture shown in FIG. 6. The etchant was Kodak 1015 Flush Fluid (1015 FF) solution (pH 11.3). Using the recirculation system described in Example 2, the pressure was set to 25 psi, and the temperature of the etching environment was adjusted to 71.0° C. The progress of etching of the borosilicate glass was followed by low coherence interferometry. The optical thickness measurements are shown in FIG. 13. From a linear fit of the in situ monitoring of the optical thickness (fit shown in FIG. 13, slope=23.7 optical nm/h) divided by the refractive index of the glass (1.46), the etch rate was determined to be 16.2 nm/h. After exposure to the etchant for 21.5 h, the borosilicate glass coupon was analyzed by profilometry at the boundary between the glass surface exposed to the etchant in the chamber and glass surface protected by the gasket. Based on the profilometry traces and the time of exposure, the rate of etching at the edges was 19 nm/h.

### EXAMPLE 4

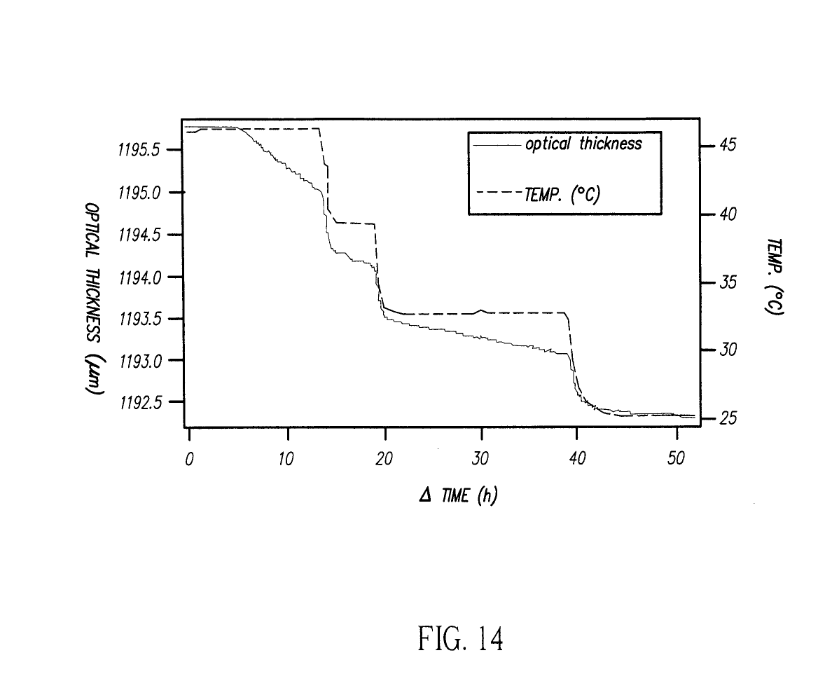

This examples shows how low coherence interferometry can be used to measure in situ etch rates at different temperatures for a homogeneous material using an opaque etchant. A silicon coupon (Si(100)) (709.7 sq mm, 0.35 mm thick) polished on both sides was mounted the fixture shown in FIG. 6. The etchant was an opaque dimethylethanolamine buffer (pH 8.45) containing carbon black. Using the recirculation system described in Example 2, the pressure was set to 59 psi, and the temperature of the etching environment was adjusted to 46.2° C. The progress of etching of silicon was followed by low coherence interferometry. The experimental data including the etching chamber temperature and optical thickness measurements by low coherence interferometry are shown in FIG. 14. After an induction period of approximately 5 h, the data from the in situ monitoring by low coherence interferometry show etching of the silicon has begun. Subsequently the temperature was adjusted to different values in order to obtain a temperature profile for etching of the silicon by the opaque dimethylethanolamine buffer. Based on linear fits of the data at the selected temperatures and taking into to account the refractive index for silicon, the etch rates and corresponding temperatures were determined to be 26.5 nm/h at 46.2° C., 13.6 nm/h at 39.4° C., 6.4 nm/h at 32.8° C., and 2.7 nm/h at 25.1° C.

### EXAMPLE 5

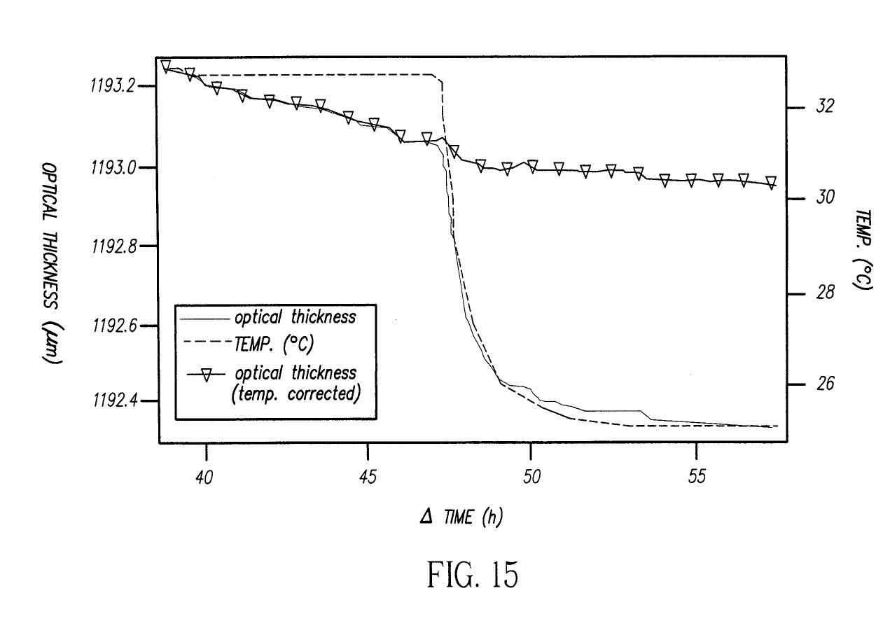

This example shows how temperature corrections can be applied to in situ etching measurements made by low coherence interferometry. From optical thickness data shown in FIG. 14 and from Example 1, it can be seen that temperature changes result in optical thickness changes. When the temperature changes, so does the optical thickness. In order to separate the effects of temperature changes on optical thickness from the changes in optical thickness due to etching, a temperature correction may be applied. A subset of the data from FIG. 14 is presented in FIG. 15 and includes temperature-corrected optical thickness data, showing only optical thickness changes due to etching.

### EXAMPLE 6

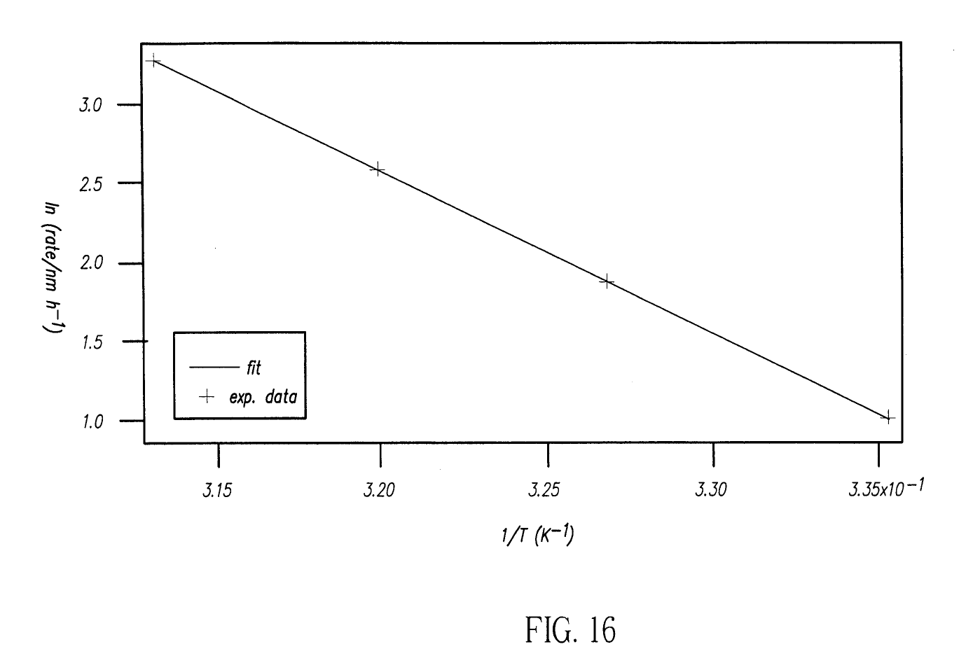

This example shows how in situ etch rates measured by low coherence interferometry can be used to measure temperature profiles for etching of materials. The experimental data presented in FIG. 14 can be used to measure the temperature profile of etching of silicon in the opaque dimethylethanolamine buffer. An Arrhenius temperature-dependence model has been applied to the etching rates and temperatures (listed in Example 4). The experimental data and the Arrhenius fit are shown in FIG. 16. The Arrhenius model for variation of rate constants with temperature is described in (J. H. Espenson, Chemical Kinetics and Reaction Mechanisms, McGraw-Hill, Inc., USA, 1981, pp 116-118). The Arrhenius activation energy for this etching process is determined to be 20.6 kcal/mol.

### EXAMPLE 7

Table 1 lists etching rates for a range of materials determined by low coherence interferometry using the fixtures and recirculation systems described in the previous examples. The experimental conditions including the etchant, the pH value of the etchant, the pressure in the etching chamber, and the temperature in the etching chamber have been provided in the table. The list includes the homogeneous materials (samples A, B, C, and D), materials comprised of a substrate and one coating (samples E, F, and G), and materials comprised of a substrate and two coatings (samples H and I). The etch rates in Table 1 are given for the substrate itself in the case of homogeneous materials (A, B, C, and D). For the materials with coatings, the etch rates are for the topmost coating; for a one layer coating, the topmost coating is coating 1 (E, F, and G), for a two-layer coating the topmost coating is coating 2 (H and I). For the homogeneous materials, the optical thickness is related to the material thickness by dividing the optical thickness by the refractive index of the material, as in Examples 2-4. For the coated materials, approximate coating thicknesses prior to etching have been provided in the table. For the coated substrates, the relationship between optical thickness and material thickness, including coating thickness, is determined by the complete interferogram (equation 8), which includes the refractive indices and thicknesses of the coatings and of the substrate. The substrates in Table 1 include substrates polished on both sides (double-side polish, dsp) and substrates polished on one side only (single-side polish, ssp). Si(100) is 100-oriented silicon metal. Si(111) is 111-oriented silicon metal. The etchants are as follows; 1015 FF is Kodak Versamark 1015 FF flush fluid and FR 1014 is Kodak Versamark FR 1014 replenisher fluid, and potassium hydroxide (1 M, KOH). Both 1015 FF and FR 1014 were obtained from Kodak Versamark. The 1 M KOH was prepared from potassium hydroxide pellets and water prior to use.

The data presented in Table 1 show that low coherence interferometry can be used to measure etch rates for many materials, including different homogeneous materials such as Si(100) (samples A and B), Si(111) (sample C), and quartz (sample D), as well as for coated materials with a variety of coatings, such as silicon nitride (sample G), silicon oxynitride (sample H), and different silicon oxide glasses (samples E, F, and I). The table includes data collected at elevated pressure, such as at 60 psi and temperature, such as at 88° C. (sample G). A large range of etch rates are also demonstrated, from low rates of a few nm/h to nearly 2000 nm/h (sample B). The ability to measure double-side polished, such as sample A, and single-side polished materials, such as sample B, is also demonstrated. This expands the utility of the method. Furthermore, the ability to measure both dsp and ssp samples shows that this method can be used even when signal intensities are significantly reduced, as is observed in ssp materials relative to dsp materials.

TABLE 1
Etch Rates for Materials Measured by Low Coherence Interferometry.

| sample | | coating 1 | coating 2 | | | Press./ | | etch rate |
|---|---|---|---|---|---|---|---|---|
| ID | substrate | (thick, nm) | (thick, nm) | etchant | pH | psi | temp/° C. | (nm/h) |
| A | Si(100), dsp | | | 1015 FF | 11.3 atm | | 48.6 | 118 |
| B | Si(100), ssp | | | 1015 FF | 11.3 | 60 | 73.1 | 1910 |
| C | Si(111), dsp | | | 1015 FF | 11.3 atm | | 51.1 | 59.6 |
| D | quartz | | | 1015 FF | 11.3 | 25 | 75 | 7.3 |
| E | Si(100), ssp | Spin-on- | | FR 1014 | 10.6 atm | | 67.1 | 3.7 |
| | | glass (600) | | | | | | |
| F | Si(100), dsp | Tetraethoxy- | | 1 M | 13.3 atm | | 28 | 4.7 |
| | | silane | | KOH | | | | |
| | | (TEOS) | | | | | | |
| | | glass (500) | | | | | | |
| G | Si(100), dsp | Silicon | | 1015 FF | 11.3 | 60 | 88 | 4.7 |
| | | nitride (120) | | | | | | |
| H | Si(100), dsp | Boro- | Silicon | 1015 FF | 11.3 | 60 | 73.4 | 15.7 |
| | | phospho- | oxynitride | | | | | |
| | | slicate glass | (800) | | | | | |
| | | (300) | | | | | | |
| I | Si(100), dsp | Tetraethoxy- | Boro- | 1015 FF | 11.3 | 60 | 50.5 | 23.5 |
| | | silane | phospho- | | | | | |
| | | (TEOS) | slicate glass | | | | | |
| | | glass (200) | (500) | | | | | |

Taken together, the data presented in Table 1, considered with the previous examples shows how different materials respond to a variety of etchants. Consequently, the etch rate can be used to characterize the composition of a material.

The invention has been described in detail with particular reference to certain preferred embodiments thereof, but it will be understood that variations and modifications can be effected within the spirit and scope of the invention.

### PARTS LIST

5 Sample of material
6 Gasket
7 Substrate
9 Coating
10 Computer, Instrument Control and Display Unit
11 Substrate back surface
13 Substrate Coating interface
15 Coating exposed surface
20 Bidirectional Communication Interface
30 optical probe
32 sample optical fiber
34 Sample lens
35 optical probe mount
36 Gimbal mount
37 Angular positioning means
38 Optical fiber connector
39 Focusing means
40 Etchant
41 Chamber sample pocket
42 Etchant jet assembly
43 Etching chamber sample recess
44 Temperature Measurement Means
45 Chamber feed through
46 Etching Chamber
47 Chamber probe mount
48 Window
49 Chamber Housing
50 Measurement System
52 Boltholes
54 Bolt receptacles
56 Etchant inlet
57 temperature probe receptacle
58 Etchant outlet
59 Etchant cavity
70 Interferometer
76 Broadband Light Source
77 Broadband Source Optical Fiber
78 Fiber Optical Circulator
79 Optical Fiber
96 Laser Interference Detector
97 Low-Coherence Light Interference Detector
101 Coherent Source
102 Optical Fiber
103, Wavelength Division Multiplexer (WDM)
104 Optical Fiber
105 Optical Fiber
106 Fiber Optic 2 by 2 Coupler
107 Wavelength Division Multiplexer (WDM)
108, 109 Piezoelectric Modulator
110 Optical Fiber
111 Optical Fiber
112 Optical Fiber
113 Optical Fiber
114 Mirror
115 Mirror
116 Optical Fiber
117 Optical Fiber
118 Optical Fiber
120 Wavelength Division Multiplexer (WDM)

1. A method of measuring the thickness and the rate of change of thickness of a material having a surface while the material is being etched, comprising:
a) illuminating the material with low coherence light, a portion of the which transmits through the material and a portion of which is reflected;
b) etching the material surface and while etching, collecting a portion of the reflected light from each optical interface of the material with a low coherence light interferometer;
c) calculating the thickness and rate of change of thickness of the material or part of the material according to the obtained interferometric data; and
d) storing or displaying the resultant thickness and rate of change of thickness of the material.

2. The method of claim 1 wherein the surface of the material is disposed within a chamber and applying etchant to the surface of the material in the chamber for removal of the material.

3. The method of claim 1 further including providing the material as a coated substrate and wherein the material surface being etched is a coating on the substrate.

4. The method of claim 1, wherein the thickness of the material is calculated in step c) by using the peak locations of adjacent maxima obtained from the interferometer data and applying an algorithm to determine the thickness of the material.

5. The method of claim 1 where the rate of change of thickness of the material is calculated in step c) by using the peak locations of adjacent maxima obtained from the interferometer data and applying an algorithm to determine the thickness of the material at a first time and by using the peak locations of adjacent maxima obtained from the interferometer data and applying the algorithm to determine the thickness of the material at a second time and subtracting the thickness of the material at the second time from the thickness of the material at the first time to obtain an incremental thickness change, and dividing the incremental thickness change by the difference in time.

6. The method of claim 1, wherein the thickness of the material is calculated in step c) by determining the location of the peak amplitude maxima in an interferogram that correspond to optical interfaces in the material and applying an algorithm to a subset of points around the peak to determine the location of the true location of the optical interfaces.

7. The method of claim 1 where the rate of change of thickness of the material is calculated in step c) by determining the location of the peak amplitude maxima in an interferogram that correspond to optical interfaces in the material and applying an algorithm to a subset of points around the peak to determine the location of the true location of the optical interfaces at a first time, and by determining the location of the peak amplitude maxima in an interferogram that correspond to optical interfaces in the material and applying an algorithm to a subset of points around the peak to determine the location of the true location of the optical interfaces at a second time, and subtracting the thickness of the material at the second time from the thickness of the material at the first time to obtain an incremental thickness change, and dividing the incremental thickness change by the difference in time.

8. The method of claim 1 further including using the results of step c to characterize the material being etched.

9. A method of measuring the thermo optic coefficient of a material comprising:
a) illuminating the material with low coherence light, a portion of which transmits through the material and a portion of which is reflected;
b) heating or cooling the material over a defined time interval;
c) collecting a portion of the reflected light from each optical interface of the material with a low coherence light interferometer at a multiplicity of times within the defined time interval;
d) calculating the optical thickness of the material at the said multiplicity of times according to the obtained interferometric data;
e) monitoring the temperature of the material as a function of time during the defined time interval;
f) calculating the thermo optic coefficient of the material by determining the slope of the change in optical thickness with respect to temperature during the defined time interval; and
g) storing or displaying the thermo optic coefficient of the material.

10. The method of claim 1 further comprising measuring the temperature of the material as a function of time during etching and step c) includes using the temperature data when calculating the rate of change of thickness of the material.

11. A method of measuring the etch rate as a function of temperature of a material having a surface while the material is being etched comprising:
a) bringing the material to a first temperature
b) illuminating the material with low coherence light, a portion of which transmits through the material and a portion of which is reflected;
c) collecting a portion of the reflected light from each optical interface of the material with a low coherence light interferometer while the material is being etched;
d) calculating the thickness or the rate of change of thickness of the material or part of the material according to the obtained interferometric data; and
e) storing or displaying the resultant thickness or rate of change of thickness of the material.
f) changing the temperature of the material to a different value while continuing to perform steps b) through e)

12. A method of measuring the thickness and the rate of etching while the material is being etched and changing the etching rate during etching, comprising:
a) illuminating the material with low coherence light, a portion of which transmits through the material and a portion of which is reflected;
b) heating or cooling the material to a first temperature series of specified over a defined time interval;
c) etching the material surface and while etching, collecting a portion of the reflected light from each optical interface of the material with a low coherence light interferometer at a multiplicity of times within the defined time interval;
d) calculating the optical thickness of the material at the said multiplicity of times according to the obtained interferometric data;
e) monitoring the temperature of the material as a function of time during the defined time interval;
f) calculating the thermo optic coefficient of the material by determining the slope of the change in optical thickness with respect to temperature during the defined time interval; and
g) changing the etching rate in accordance with the calculated thermo optic coefficient.
